(19) United States
(12) Patent Application Publication
(10) Pub. No.: US 2020/0285044 A1
(43) Pub. Date: Sep. 10, 2020

(54) DISPLAY DEVICE, DISPLAY CONTROL METHOD, AND STORAGE MEDIUM

(71) Applicant: HONDA MOTOR CO., LTD., Tokyo (JP)

(72) Inventors: Junpei Noguchi, Wako-shi (JP); Yasushi Shoda, Wako-shi (JP); Yuki Hara, Wako-shi (JP); Ryoma Taguchi, Tokyo (JP); Yuta Takada, Tokyo (JP)

(21) Appl. No.: 16/807,206

(22) Filed: Mar. 3, 2020

(30) Foreign Application Priority Data
Mar. 8, 2019 (JP) 2019-042786

(51) Int. Cl. G02B 26/08; G08G 1/16; B60K 35/00; G02B 27/01

(52) U.S. Cl. CPC G02B 26/0816; G08G 1/168; B60K 35/00; G05D 1/0088; B60K 2370/1529; B60K 2370/167; B60K 2370/175; G02B 27/0101

(57) ABSTRACT

A display device that is mounted in a vehicle includes a light projection device configured to emit projection light, an adjuster configured to adjust a direction of the projection light emitted by the light projection device, and a control device configured to control the light projection device and the adjuster. The control device is configured to control the adjuster to change the direction of the projection light according to whether the vehicle travels by autonomous parking control or whether the vehicle travels without using the autonomous parking control.

### CROSS-REFERENCE TO RELATED APPLICATION

This application claims priority to and the benefit from Japanese Patent Application No. 2019-042786, filed on Mar. 8, 2019, the contents of which are hereby incorporated by reference into the present application.

### BACKGROUND OF THE INVENTION

### Field of the Invention

The present invention relates to a display device, a display control method, and a storage medium.

### Description of Related Art

Automatic control of a vehicle has been studied. Regarding this technique, an automated driving device that images the surroundings of a vehicle with movement of a key to a parked vehicle from a specific location such as a storage location for a key as a trigger, compares the captured image with an image of a user of the vehicle, and moves the vehicle to a predetermined position when the presence of a user is recognized is known (for example, see Japanese Unexamined Patent Application, First Publication No. 2017-126133).

### SUMMARY OF THE INVENTION

When a vehicle is moved by automated driving control as described above, a person outside the vehicle (for example, a traffic participant or a user of the vehicle) is not able to understand a status of the vehicle (whether the vehicle is exiting, whether the vehicle is parking, or the like).

The invention is made in consideration of the above-mentioned circumstances and an object thereof is to provide a display device, a display control method, and a storage medium that can allow a person outside a vehicle to easily understand a status of the vehicle which is being automatically parked.

A display device, a display control method, and a storage medium according to the invention employ the following configurations:

(1) A display device according to an aspect of the invention is mounted in a vehicle, the display device includes a light projection device configured to emit projection light, an adjuster configured to adjust a direction of the projection light emitted by the light projection device, and a control device configured to control the light projection device and the adjuster. The control device is configured to control the adjuster to change the direction of the projection light according to whether the vehicle travels by autonomous parking control or whether the vehicle travels without using the autonomous parking control.

(2) In the aspect of (1), the adjuster includes a reflecting plate configured to reflect the projection light and an actuator configured to change a direction of the reflecting plate. The control device is configured to control the actuator to change a reflecting direction of the projection light reflected by the reflecting plate according to whether the vehicle travels by the autonomous parking control or whether the vehicle travels without using the autonomous parking control.

(3) In the aspect of (2), the control device is configured to control the actuator to output the projection light reflected by the reflecting plate to an outside of the vehicle in a case where the vehicle travels by the autonomous parking control.

(4) In the aspect of (2) or (3), the control device is configured to control the actuator to make the projection light reflected by the reflecting plate be visible to a person outside the vehicle on the basis of position information of the person.

(5) In the aspect of any one of (2) to (4), the control device is configured to control the actuator to make the projection light reflected by the reflecting plate be visible to a person outside the vehicle on the basis of a sight line position of the person.

(6) In the aspect of any one of (1) to (5), the projection light includes information for displaying an image indicating an operating state of the vehicle.

(7) In the aspect of any one of (2) to (5), the reflecting plate is a head-up display device.

(8) In the aspect of any one of (1) to (7), the control device is configured to control the light projection device to change a projection mode of the projection light on the basis of brightness outside the vehicle.

(9) In the aspect of (8), the control device is configured to control the light projection device to increase luminance of the projection light as outside of the vehicle becomes brighter.

(10) In the aspect of any one of (1) to (9), the control device is configured to control the light projection device to change a projection mode of the projection light on the basis of weather outside the vehicle.

(11) In the aspect of any one of (1) to (10), the control device is configured to control the light projection device to change a projection mode of the projection light on the basis of a speed of the vehicle.

(12) In the aspect of (11), the control device is configured to control the light projection device to increase a blinking period of the projection light as the speed of the vehicle decreases.

(13) In the aspect of any one of (1) to (12), the control device is configured to control the light projection device to emit the projection light only in a case where a light intensity outside the vehicle is equal to or less than a predetermined threshold value.

(14) In the aspect of any one of (1) to (13), the control device is configured to control the light projection device to prevent from emitting the projection light in a case where there are no persons outside the vehicle.

(15) A display control method according to one aspect of the invention causes a computer of a display device, which is mounted in a vehicle and includes a light projection device configured to emit projection light and an adjuster configured to adjust a direction of the projection light emitted by the light projection device, to control the adjuster to change the direction of the projection light according to whether the vehicle travels by autonomous parking control or whether the vehicle travels without using the autonomous parking control.

(16) A non-transitory computer-readable storage medium according to one aspect of the invention stores a program, the program causing a computer of a display device, which is mounted in a vehicle and includes a light projection device configured to emit projection light and an adjuster configured to adjust a direction of the projection light emitted by the light projection device, to control the adjuster to change the direction of the projection light according to whether the vehicle travels by autonomous parking control or whether the vehicle travels without using the autonomous parking control.

According to the aspects of (1) to (6) and (13) to (16), it is possible to allow a person outside a vehicle to easily understand a status of the vehicle which is being automatically parked.

According to the aspect of (7), it is possible to notify a person outside a vehicle of a status of the vehicle which is being automatically parked without providing a separate outside notification function or a dedicated notification unit.

According to the aspects of (8) to (12), it is possible to more effectively notify to person outside a vehicle of a status of the vehicle.

### BRIEF DESCRIPTION OF THE DRAWINGS

FIG. 1 is a diagram showing a configuration of a vehicle system employing a display device according to a first embodiment;

FIG. 2 is a diagram showing a configuration of a passenger compartment of a vehicle in which a HUD device is mounted according to the first embodiment;

FIG. 3 is a diagram schematically showing a configuration of the HUD device for allowing a driver to visually recognize a virtual image according to the first embodiment;

FIG. 4 is a diagram showing a manner of appearance of a virtual image for a driver according to the first embodiment;

FIG. 5 is a diagram schematically showing a configuration of the HUD device for allowing a person outside the vehicle to visually recognize a virtual image according to the first embodiment;

FIG. 6 is a diagram showing a manner of appearance of a virtual image for a person outside the vehicle according to the first embodiment;

FIG. 7 is a block diagram showing an example of a configuration of a display control device according to the first embodiment;

FIG. 8 is a diagram showing functional configurations of a first controller and a second controller according to the first embodiment;

FIG. 9 is a diagram schematically showing a scenario in which an autonomous parking event is performed according to the first embodiment;

FIG. 10 is a diagram showing an example of a configuration of a parking lot control device according to the first embodiment;

FIG. 11 is a flowchart showing an example of an operation flow of the HUD device according to the first embodiment;

FIG. 12 is a flowchart showing an example of an operation flow of an HUD device according to a second embodiment; and

FIG. 13 is a diagram showing an example of a hardware configuration of a display control device according to an embodiment.

### DETAILED DESCRIPTION OF THE INVENTION

Hereinafter, a display device, a display control method, and a storage medium according to an embodiment of the invention will be described with reference to the accompanying drawings. The display device according to the invention is mounted in a vehicle (hereinafter referred to as a vehicle M). The display device allows a driver to visually recognize an image on information for supporting the driver's driving to overlap a forward scene of the vehicle M at the time of manual driving. On the other hand, at the time of autonomous parking, the display device allows a person outside the vehicle (such as a traffic participant or a user of the vehicle) to visually recognize an image indicating a status of the vehicle M. The display device is, for example, a head-up display device (hereinafter referred to as an HUD device). In the following description, it is assumed that the display device is an HUD device and the vehicle M is subjected to automatic valet parking by automated driving.

In the following description, positional relationships or the like will be appropriately described using an XYZ coordinate system. A Z direction denotes a vertical direction, an X direction denotes one direction of a horizontal plane perpendicular to the Z direction, and a Y direction denotes another direction of the horizontal plane. The Z direction denotes a height direction of the vehicle M, the X direction denotes a longitudinal direction of the vehicle M, and the Y direction denotes a width direction of the vehicle M.

### First Embodiment

### [Entire Configuration]

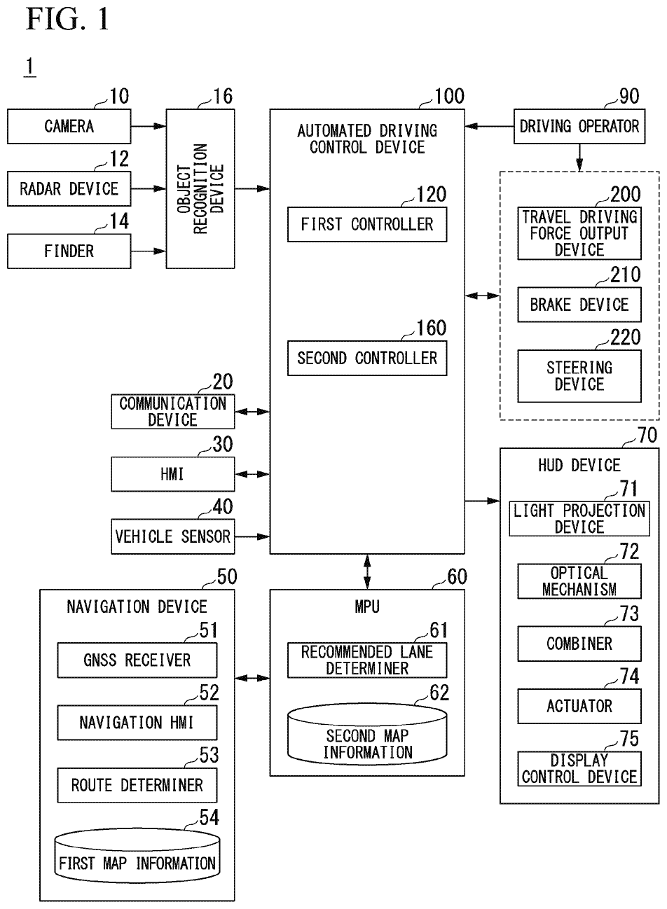

FIG. 1 is a diagram showing a configuration of a vehicle system 1 employing a display device according to a first embodiment. A vehicle in which the vehicle system 1 is mounted is, for example, a vehicle with two wheels, three wheels, four wheels, or the like and a drive source thereof is an internal combustion engine such as a diesel engine or a gasoline engine, an electric motor, or a combination thereof. An electric motor operates using electric power which is generated by a power generator connected to the internal combustion engine or electric power which is discharged from a secondary battery or a fuel cell.

The vehicle system 1 includes, for example, a camera 10, a radar device 12, a finder 14, an object recognition device 16, a communication device 20, a human-machine interface (HMI) 30, a vehicle sensor 40, a navigation device 50, a map positioning unit (MPU) 60, an HUD device 70, a driving operator 90, an automated driving control device 100, a travel driving force output device 200, a brake device 210, and a steering device 220. These devices or instruments are connected to each other via a multiplex communication line such as a controller area network (CAN) communication line, a serial communication line, a radio communication network, or the like. The configuration shown in FIG. 1 is only an example and part of the configuration may be omitted or another configuration may be added thereto.

The camera 10 is, for example, a digital camera using a solid-state imaging device such as a charge coupled device (CCD) or a complementary metal oxide semiconductor (CMOS). The camera 10 is attached to an arbitrary position on a vehicle M in which the vehicle system 1 is mounted. For example, when the front of the vehicle M is imaged, the camera 10 is attached to an upper part of a front windshield, a rear surface of a rearview mirror, or the like. The camera 10 images surroundings of the vehicle M, for example, periodically and repeatedly. The camera 10 may be a stereoscopic camera.

The radar device 12 radiates radio waves such as millimeter waves to the surroundings of the vehicle M, detects radio waves (reflected waves) reflected by an object, and detects at least a position (a distance and a direction) of the object. The radar device 12 is attached to an arbitrary position on the vehicle M. The radar device 12 may detect a position and a speed of an object using a frequency modulated continuous wave (FM-CW) method.

The finder 14 is a Light Detection and Ranging device (LIDAR). The finder 14 applies light to the surroundings of the vehicle M and measures scattered light. The finder 14 detects a distance to an object on the basis of a time from emission of light to reception of light. The light which is applied is, for example, a pulse-like laser beam. The finder 14 is attached to an arbitrary position on the vehicle M.

The object recognition device 16 performs a sensor fusion process on results of detection from some or all of the camera 10, the radar device 12, and the finder 14 and recognizes a position, a type, a speed, and the like of an object. The object recognition device 16 outputs the result of recognition to the automated driving control device 100. The object recognition device 16 may output the results of detection from the camera 10, the radar device 12, and the finer 14 to the automated driving control device 100 without any change. The object recognition device 16 may be omitted from the vehicle system 1.

The communication device 20 communicates with other vehicles near the vehicle M, a parking lot management device, or various server devices, for example, using a cellular network, a Wi-Fi network, Bluetooth (registered trademark), or dedicated short range communication (DSRC). Details of the function of the parking lot management device will be described later.

The HMI 30 presents various types of information to an occupant of the vehicle M and receives an input operation from the occupant. The HMI 30 includes various display devices, speakers, buzzers, touch panels, switches, and keys.

The vehicle sensor 40 includes a vehicle speed sensor that detects a speed of the host vehicle M, an acceleration sensor that detects acceleration, a yaw rate sensor that detects an angular velocity around a vertical axis, and a direction sensor that detects a direction of the host vehicle M.

The navigation device 50 includes, for example, a global navigation satellite system (GNSS) receiver 51, a navigation HMI 52, and a route determiner 53. The navigation device 50 stores first map information 54 in a storage device such as a hard disk drive (HDD) or a flash memory. The GNSS receiver 51 identifies a position of the vehicle M on the basis of signals received from GNSS satellites. The position of the vehicle M may be identified or complemented by an inertial navigation system (INS) using the output of the vehicle sensor 40. The navigation HMI 52 includes a display device, a speaker, a touch panel, and keys. All or part of the navigation HMI 52 may be shared by the HMI 30. For example, the route determiner 53 determines a route (hereinafter, referred to as a route on a map) from the position of the vehicle M identified by the GNSS receiver 51 (or an input arbitrary position) to a destination input by an occupant using the navigation HMI 52 with reference to the first map information 54. The first map information 54 is, for example, information in which road shapes are expressed by links indicating roads and nodes connected by the links. The first map information 54 may include a curvature of a road or point of interest (POI) information. The route on a map is output to the MPU 60. The navigation device 50 may perform guidance for a route using the navigation HMI 52 on the basis of the route on a map. The navigation device 50 may be realized, for example, by a function of a terminal device such as a smartphone or a tablet terminal which is carried by an occupant. The navigation device 50 may transmit a current position and a destination to a navigation server via the communication device 20 and may acquire a route which is equivalent to the route on a map from the navigation server.

The MPU 60 includes, for example, a recommended lane determiner 61 and stores second map information 62 in a storage device such as an HDD or a flash memory. The recommended lane determiner 61 divides the route on a map supplied from the navigation device 50 into a plurality of blocks (for example, every 100 [m] in a vehicle traveling direction) and determines a recommended lane for each block with reference to the second map information 62. The recommended lane determiner 61 determines on which lane from the leftmost the vehicle will travel. When there is a branching point in the route on a map, the recommended lane determiner 61 determines a recommended lane such that the host vehicle M travels on a rational route for traveling to a branching destination.

The second map information 62 is map information with higher precision than the first map information 54. The second map information 62 includes, for example, information of the center of a lane or information of boundaries of a lane. The second map information 62 may include road information, traffic regulation information, address information (addresses and postal codes), facility information, and phone number information. The second map information 62 may be updated from time to time by communicating with another device using the communication device 20.

The HUD device 70 allows an observer to see a virtual image by projecting light including an image to a combiner which is provided in front of a front windshield when seen from a driver. For example, the HUD device 70 allows a driver to see an image associated with information for supporting the driver's driving to overlap a scene in front of the vehicle M when the vehicle M moves by manual driving or when the vehicle M moves by automated driving in a state in which the driver is in the vehicle M. The information for supporting the driver's driving includes, for example, information such as a speed of the vehicle M, a driving force distribution ratio, an engine rotation speed, an operating state of a driving support function, a shift position, a sign recognition result, and crossing positions. Examples of the driving support function include an adaptive cruise control (ACC) function, a lane keep assist system (LKAS) function, a collision mitigation brake system (CMBS) function, and a traffic jam assist function. By using this HUD, a driver can understand various types of information which are displayed while maintaining a direction of a sight line forward at the time of driving.

On the other hand, when the vehicle M is being automatically parked, the HUD device 70 allows a person outside the vehicle to visually recognize an image indicating a status of the vehicle M. For example, when the vehicle M is subjected to automatic valet parking by automated driving, the HUD device 70 allows a person outside the vehicle to visually recognize an image indicating a status of the vehicle M. The image indicating a status of the vehicle M is, for example, an image (for example, a character string) including information indicating that the vehicle M is being autonomously driven (for example, being automatically parked or automatically exiting) and light blinking in a predetermined pattern.

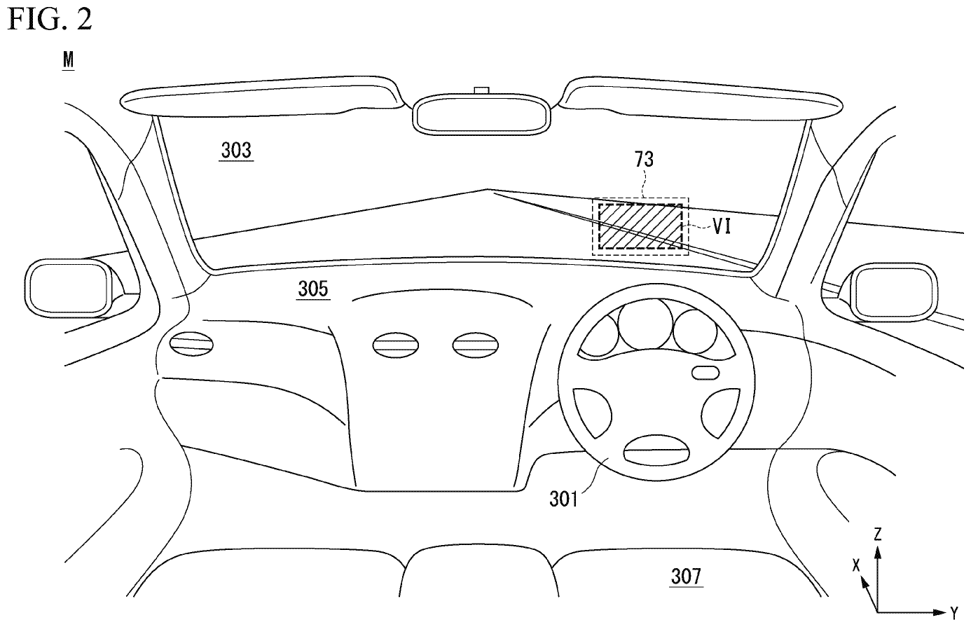

FIG. 2 is a diagram showing a configuration of a passenger compartment of the vehicle M in which the HUD device 70 is mounted according to the first embodiment. In the vehicle M, for example, a steering wheel 301 that controls steering of the vehicle M, a front windshield 303 that partitions the inside and the outside of the vehicle, and an instrument panel 305 are provided. The HUD device 70 allows a driver sitting on a driver's seat 307 to visually recognize a virtual image VI associated with information for supporting driving, for example, by projecting light including an image to a combiner 73 which is provided before the front windshield 303 in front of the driver's seat 307. The HUD device 70 allows a person outside the vehicle to visually recognize a virtual image VI indicating a status of the vehicle M by projecting light including an image to the combiner 73.

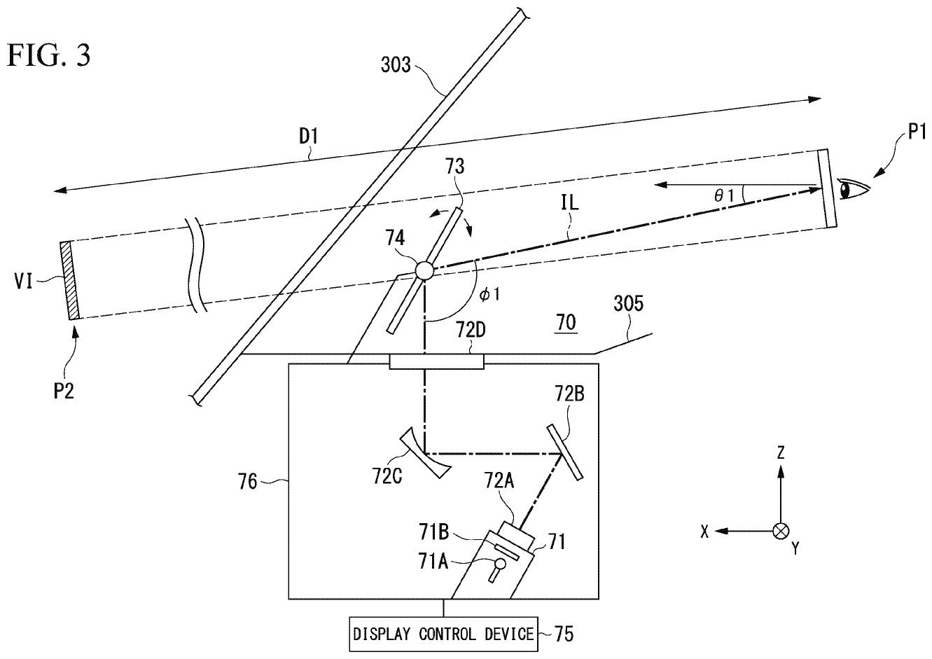

As shown in FIG. 1, the HUD device 70 includes, for example, a light projection device 71, an optical mechanism 72, a combiner 73 (an example of a reflecting plate) (an adjuster), an actuator 74 (an adjuster), and a display control device 75 (a control device). FIG. 3 is a diagram schematically showing a configuration for allowing a driver to visually recognize a virtual image VI in the HUD device 70 according to the first embodiment.

The light projection device 71 includes, for example, a light source 71A and a display device 71B. The light source 71A is, for example, a cold cathode ray tube or a light emitting diode. The light source 71A outputs visible light (projection light) corresponding to a virtual image VI which is visually recognized by a driver or a person outside the vehicle. The display device 71B controls transmission of visible light from the light source 71A. The display device 71B is, for example, a thin film transistor (TFT) type liquid crystal display device (LCD). The display device 71B controls a plurality of pixels and causes a virtual image VI to include image elements and determines a display mode (a manner of appearance) of the virtual image VI by controlling a degree of transmission of each color element of visible light from the light source 71A. In the following description, visible light including an image transmitted by the display device 71B is referred to as image light IL. The display device 71B may be an organic electroluminescence (EL) display. In this case, the light source 71A may be omitted.

The optical mechanism 72 includes, for example, an image formation position adjustment device 72A, a plane mirror 72B, a concave mirror 72C, and a light projection cover 72D. The image formation position adjustment device 72A includes, for example, one or more lenses. The position of each lens can be adjusted, for example, in an optical axis direction. The image formation position adjustment device 72A is provided, for example, in a path of the image light IL output from the light projection device 71. The image formation position adjustment device 72A transmits the image light IL and emits the image light IL to the combiner 73.

The image formation position adjustment device 72A can adjust a distance (hereinafter referred to as a virtual image visible distance D1) from a sight line position P1 of the driver to a formation position (an image formation position at which the image light IL is formed as a virtual image VI) P2 at which the image light IL is formed as a virtual image VI, for example, by changing the position of each lens. The sight line position P1 of the driver is a position on which the image light IL reflected by the plane mirror 72B, the concave mirror 72C, and the combiner 73 is focused and is a position at which the driver's eyes are supposed to be located.

The plane mirror 72B reflects visible light (that is, image light IL) which is emitted from the light source 71A and is transmitted by the display device 71B to the concave mirror 72C.

The concave mirror 72C reflects the image light IL reflected by the plane mirror 72B to the combiner 73. The concave mirror 72C is supported to be rotatable about a Y axis which is parallel to the width direction of the vehicle M.

The light projection cover 72D is a member having light-transmitting characteristics. The light projection cover 72D is formed of, a synthetic resin such as plastic. The light projection cover 72D is provided to cover an opening which is formed on the top surface of a casing 76 of the light projection device 71. An opening or a member having light-transmitting characteristics is also provided in the instrument panel 305. Accordingly, the image light IL reflected by the concave mirror 72C can pass through the light projection cover 72D and be incident on the combiner 73, and foreign materials such as dust or droplets are prevented from entering the casing 76.

The image light IL incident on the combiner 73 is reflected by the combiner 73 and is focused on the driver's sight line position P1. At this time, when the driver's eyes are located at the driver's sight line position P1, the driver visually recognizes an image formed by the image light IL as if it were displayed in front of the vehicle M. The combiner 73 is provided before the front windshield 303 when seen from the driver. The combiner 73 is a member having light-transmitting characteristics. The combiner 73 is, for example, a transparent plastic disc. The combiner 73 is supported to be rotatable about the Y axis which is parallel to the width direction of the vehicle M by the actuator 74.

The actuator 74 adjusts the direction of the combiner 73 around the Y axis which is parallel to the width direction of the vehicle M. The combiner 73 and the actuator 74 may be accommodated in the casing 76. For example, the combiner 73 and the actuator 74 may be accommodated in the casing 76 in a state in which a power supply (or ignition) of the vehicle M is turned off and be moved to a predetermined position before the front windshield 303 when seen from the driver in a state in which the power supply (or ignition) of the vehicle M is turned on.

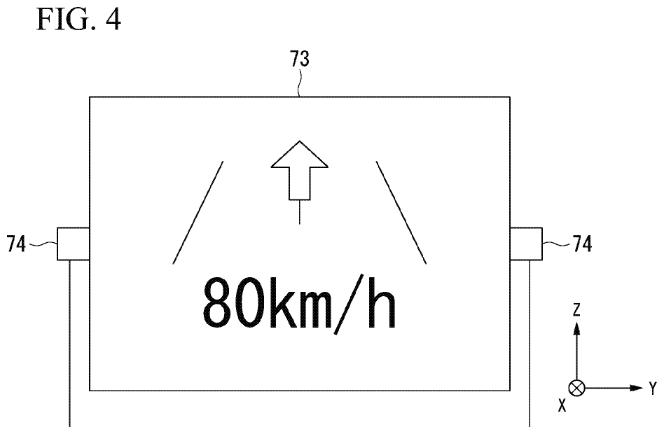

FIG. 4 is a diagram showing an example of a manner of appearance of a virtual image VI for a driver according to the first embodiment. As shown in the drawing, an image (a character string indicating a speed of “80 km/h”) associated with information for supporting a driver's driving is visually recognized to overlap a scene in front of the vehicle M by the driver.

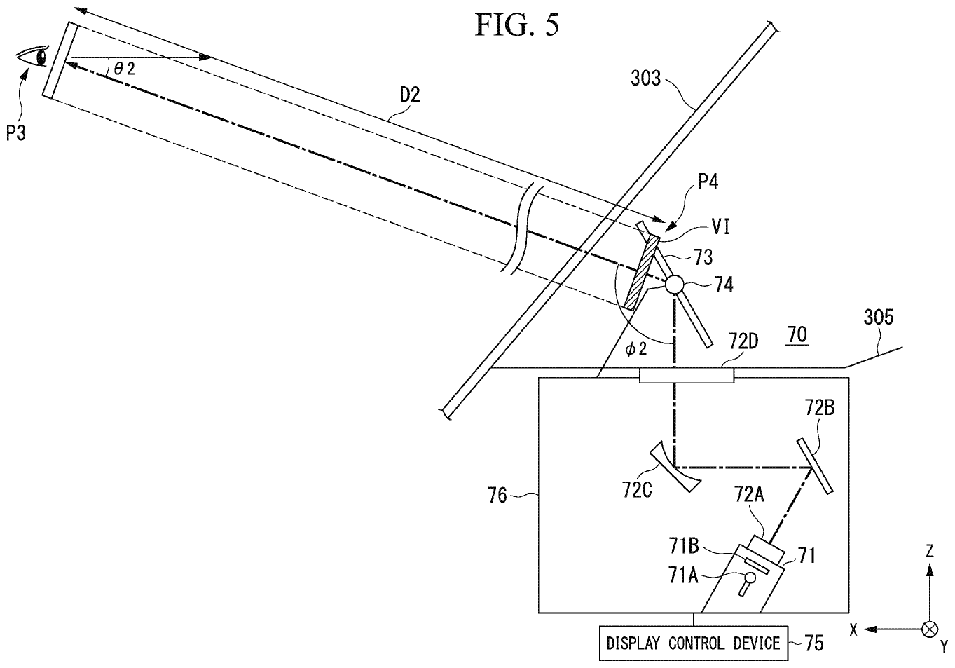

FIG. 5 is a diagram schematically showing a configuration for allowing a person outside the vehicle to visually recognize a virtual image VI in the HUD device 70 according to the first embodiment. In this case, the direction of the combiner 73 around the Y axis is adjusted by the actuator 74 such that the image light IL is reflected to the outside. The image light IL incident on the combiner 73 is reflected to the outside by the combiner 73 and is focused on a sight line position P3 of the person outside the vehicle. At this time, the person outside the vehicle visually recognizes an image formed by the image light IL as if it were displayed at a formation position P4 which is the position of the combiner 73.

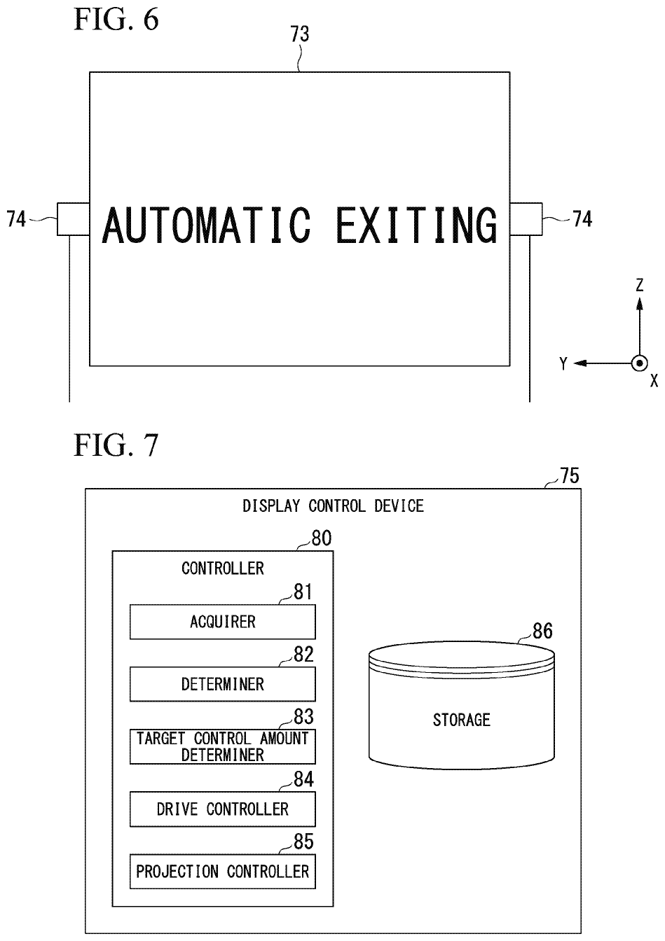

FIG. 6 is a diagram showing an example of a manner of appearance of a virtual image VI for a person outside the vehicle according to the first embodiment. As shown in the drawing, for example, an image including characters indicating the status of the vehicle M such as “automatically exiting” can be visually recognized by the person outside the vehicle. Accordingly, a person other than a user of the vehicle M who is located near the vehicle M can also be notified of the status of the vehicle M. Accordingly, the person outside the vehicle can recognize that the vehicle M is automatically exiting by automated driving control by visually recognizing the image.

The display control device 75 controls display of a virtual image VI which is visually recognized by a driver or a person outside the vehicle. The display control device 75 controls the actuator 74 such that the reflection direction of projection light (the direction of projection light) reflected by the combiner 73 changes according to whether the vehicle M travels by autonomous parking control or whether the vehicle M travels without using autonomous parking control. FIG. 7 is a block diagram showing an example of a configuration of the display control device 75 according to the first embodiment. The display control device 75 includes, for example, a controller 80 and a storage 86. The controller 80 includes, for example, an acquirer 81, a determiner 82, a target control amount determiner 83, a drive controller 84, and a projection controller 85. The elements of the controller 80 are realized, for example, by causing a processor such as a central processing unit (CPU) or a graphics processing unit (GPU) to execute a program (software). Some or all of such elements may be realized in hardware (which includes circuitry) such as a large scale integration (LSI), an application specific integrated circuit (ASIC), or a field-programmable gate array (FPGA) or may be realized in cooperation of software and hardware. The program which is executed by the processor may be stored in the storage 86, or may be stored in a removable storage medium (a non-transitory storage medium) such as a DCD or a CD-ROM and may be installed in the storage 86 by attaching the storage medium to a drive of the display control device 75.

The storage 86 is realized, for example, by a hard disk drive (HDD), a flash memory, an electrically erasable and programmable read only memory (EEPROM), a read only memory (ROM), or a random access memory (RAM). A non-transitory storage medium such as an HDD or a flash memory included in the storage 86 may be realized by another storage device which is connected via a network (for example, a wide area network), such as a network attached storage (NAS) or an external storage server. The storage 86 stores, for example, various types of process results in addition to the program which is read and executed by the processor.

The acquirer 81 acquires information indicating an operating state of the vehicle M (hereinafter referred to as operating state information) which is output by the automated driving control device 100. The operating state information includes, for example, information indicating whether autonomous parking control is being performed (under autonomous parking control). The acquirer 81 acquires surrounding information of the vehicle M which is input from the camera 10, the radar device 12, and the finder 14 via the object recognition device 16 and the automated driving control device 100. The acquirer 81 acquires, for example, information (position information) indicating a position (a sight line position or the like) of a person outside the vehicle M as the surrounding information. The sight line position of the person outside the vehicle is detected, for example, by analyzing an image captured by the camera 10 and acquiring information such as a position or a direction of a face or a sight line of a person outside the vehicle included in the captured image using a technique such as template matching. This detection process is performed, for example, by the object recognition device 16 or the recognizer 130 of the automated driving control device 100. This detection process may be performed by the HUD device 70.

The determiner 82 determines whether the vehicle M is under autonomous parking control on the basis of the operating state information of the vehicle M acquired by the acquirer 81. When the determiner 82 determines that the vehicle M is under autonomous parking control, display control in an “inside display mode” in which an image is displayed for a driver is performed thereafter. On the other hand, when the determiner 82 determines that the vehicle M is not under autonomous parking control, display control in an “outside display mode” in which an image is displayed for a person outside the vehicle is performed thereafter.

The target control amount determiner 83 determines a target virtual image visible distance (hereinafter, referred to as a target virtual image visible distance D_{TA}) and a target elevation/depression angle (hereinafter, referred to as a target elevation/depression angle θ_{TA}) on the basis of the result of determination from the determiner 82 and the surrounding information acquired by the acquirer 81.

A virtual image visible distance D1 is an optical distance from the sight line position P1 of the driver to the formation position P2 at which the image light IL is formed as a virtual image VI as shown in FIG. 3. A virtual image visible distance D2 is an optical distance from the sight line position P3 of the person outside the vehicle to the formation position P4 at which the image light IL is formed as a virtual image VI as shown in FIG. 5.

An elevation/depression angle θ1 is an angle which is formed by the horizontal direction (the X direction) passing through the sight line position P1 of the driver and the sight line direction of the driver when the virtual image VI is visually recognized by the driver as shown in FIG. 3. In other words, the elevation/depression angle θ1 is defined as an angle which is formed by the horizontal plane passing through the sight line position P1 of the driver and a line extending from the sight line position P1 of the driver to the formation position P2 of the virtual image VI. As the virtual image VI is formed lower, that is, as the sight line direction of the driver becomes lower, the elevation/depression angle θ1 increases. The elevation/depression angle θ1 is a control amount for determining a reflection angle ϕ1 of the combiner 73 (an operation parameter). The reflection angle ϕ1 is an angle which is formed by an incidence direction when the image light IL reflected by the concave mirror 72C is incident on the combiner 73 and a reflection direction when the combiner 73 reflects the image light IL as shown in FIG. 3.

An elevation/depression angle θ2 is an angle which is formed by the horizontal direction (the X direction) passing through the sight line position P3 of the person outside the vehicle and the sight line direction of the person outside the vehicle when the virtual image VI is visually recognized by the person outside the vehicle as shown in FIG. 5. In other words, the elevation/depression angle θ2 is defined as an angle which is formed by the horizontal plane passing through the sight line position P3 of the person outside the vehicle and a line extending from the sight line position P3 of the person outside the vehicle to the formation position P4 of the virtual image VI. As the virtual image VI is formed lower, that is, as the sight line direction of the person outside the vehicle becomes lower, the elevation/depression angle θ2 increases. The elevation/depression angle θ2 is a control amount for determining a reflection angle ϕ2 of the combiner 73 (an operation amount). The reflection angle ϕ2 is an angle which is formed by an incidence direction when the image light IL reflected by the concave mirror 72C is incident on the combiner 73 and a reflection direction when the combiner 73 reflects the image light IL as shown in FIG. 5.

For example, when the determiner 82 determines that the vehicle M is not under autonomous parking control, the target control amount determiner 83 determines the target virtual image visible distance D_{TA} and the target elevation/depression angle θ_{TA} such that the virtual image VI is visually recognized by the driver. For example, when the determiner 82 determines that the vehicle M is under autonomous parking control, the target control amount determiner 83 determines the target virtual image visible distance D_{TA} and the target elevation/depression angle θ_{TA} such that the virtual image VI is visually recognized by the person outside the vehicle.

The drive controller 84 determines a control signal which is instructed as a control command value to the image formation position adjustment device 72A on the basis of the target virtual image visible distance D_{TA} determined by the target control amount determiner 83 and outputs the determined control signal to the image formation position adjustment device 72A. The drive controller 84 determines a control signal which is instructed as a control command value to the actuator 74 on the basis of the target elevation/depression angle θ_{TA} determined by the target control amount determiner 83 and outputs the determined control signal to the actuator 74.

The projection controller 85 determines projection details of the image light IL which is projected to the combiner 73 on the basis of the result of determination from the determiner 82 and the surrounding information acquired by the acquirer 81. For example, when the determiner 82 determines that the vehicle M is under autonomous parking control (under automatic exiting), the projection controller 85 determines an image including characters “under automatic exiting” which is notified to the person outside the vehicle as projection details. For example, when the determiner 82 determines that the vehicle M is not under automatic exiting, the projection controller 85 determines information for supporting driving of the driver (for example, an image including characters indicating the speed of the vehicle M) as projection details. The light projection device 71 performs a projection process on the basis of the determined projection details.

The driving operator 90 includes, for example, an accelerator pedal, a brake pedal, a shift lever, a steering wheel, a deformed steering, a joystick, and other operators. A sensor that detects an amount of operation or the performance of an operation is attached to the driving operator 90, and results of detection thereof are output to some or all of the automated driving control device 100, the travel driving force output device 200, the brake device 210, and the steering device 220.

The automated driving control device 100 includes, for example, a first controller 120 and a second controller 160. The first controller 120 and the second controller 160 are realized, for example, by causing a hardware processor such as a central processing unit (CPU) to execute a program (software). Some or all of such elements may be realized in hardware (which includes circuitry) such as an LSI, an ASIC, an FPGA, or a GPU or may be realized in cooperation of software and hardware. The program may be stored in a storage device such as an HDD or a flash memory of the automated driving control device 100 (a storage device including a non-transitory storage medium) in advance, or may be installed in the HDD or the flash memory of the automated driving control device 100 by storing the program in a removable storage medium (a non-transitory storage medium) such as a DVD or a CD-ROM and attaching the storage medium to the drive device.

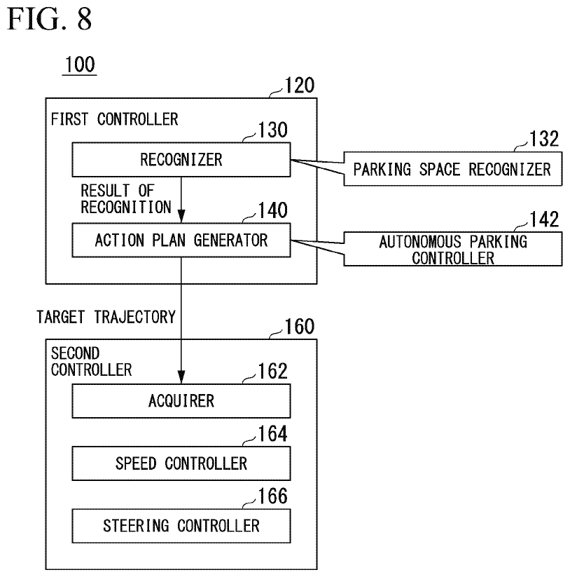

FIG. 8 is a diagram showing functional configurations of the first controller 120 and the second controller 160 according to the first embodiment. The first controller 120 includes, for example, a recognizer 130 and an action plan generator 140. The first controller 120 is realized, for example, using an artificial intelligence (AI) function and a function based on a predetermined model together. For example, a function of “recognizing a crossing” may be embodied by performing recognition of a crossing based on deep learning or the like and recognition based on predetermined conditions (such as signals which can be pattern-matched and road signs), scoring both recognitions, and comprehensively evaluating both recognitions. Accordingly, reliability of automated driving is secured.

The recognizer 130 recognizes states of a position, a speed, and acceleration of an object near the vehicle M, for example, on the basis of information input from the camera 10, the radar device 12, and the finder 14 via the object recognition device 16. For example, a position of an object is recognized, for example, as a position in an absolute coordinate system with an origin set to a representative point of the vehicle M (such as the center of gravity or the center of a drive shaft) and is used for control. A position of an object may be expressed as a representative point such as the center of gravity or a corner of the object or may be expressed as a drawn area. A “state” of an object may include an acceleration or a jerk of the object or a “moving state” (for example, whether lane change is being performed or whether lane change is going to be performed) thereof.

The recognizer 130 recognizes, for example, a lane (a traveling lane) on which the vehicle M is traveling. For example, the recognizer 130 recognizes the traveling lane by comparing a pattern of road markings near the vehicle M which are recognized from an image captured by the camera 10 with a pattern of road markings (for example, arrangement of a solid line and a dotted line) which are acquired from the second map information 62. The recognizer 130 is not limited to road markings, but may recognize the traveling lane by recognizing a traveling road boundary (a road boundary) including road markings, edges of a roadside, a curbstone, a median, and a guard rail. In this recognition, the position of the vehicle M acquired from the navigation device 50 and the result of processing from the INS may be considered. The recognizer 130 recognizes a stop line, an obstacle, a red signal, a toll gate, or other road events.

The recognizer 130 recognizes a position or a direction of the vehicle M relative to a traveling lane at the time of recognition of the traveling lane. The recognizer 130 may recognize, for example, separation of a reference point of the vehicle M from the lane center and an angle of the traveling direction of the vehicle M with respect to a line formed by connecting the lane centers as the position and the direction of the vehicle M relative to the traveling lane. Instead, the recognizer 130 may recognize a position of the reference point of the vehicle M relative to one side line of the traveling lane (a road marking or a road boundary) or the like as the position of the vehicle M relative to the traveling lane.

The recognizer 130 includes a parking space recognizer 132 that is started in an autonomous parking event which will be described later. Details of the function of the parking space recognizer 132 will be described later.

The action plan generator 140 generates a target trajectory in which the vehicle M will travel automatically (without requiring a driver's operation or the like) in the future such that the vehicle M travels on a recommended lane determined by the recommended lane determiner 61 in principle and copes with surrounding circumstances of the vehicle M. A target trajectory includes, for example, a speed element. For example, a target trajectory is expressed by sequentially arranging points (path points) at which the vehicle M will arrive. The path points are points at which the vehicle M arrives at intervals of a predetermined traveling distance (for example, about several [m]) along a road, and a target speed and a target acceleration at intervals of a predetermined sampling time (for example, about below the decimal point [sec]) are generated as part of a target trajectory in addition. Path points may be positions at which the vehicle M arrives at sampling times every predetermined sampling time. In this case, information of a target speed or target acceleration is expressed by intervals between the path points.

The action plan generator 140 may set events of automated driving in generating a target trajectory. The events of automated driving include a constant-speed travel event, a low-speed following travel event, a lane change event, a branching event, a merging event, a takeover event, and an autonomous parking event in which the vehicle M travels and parks autonomously in valet parking or the like. The action plan generator 140 generates a target trajectory based on events which are started. The action plan generator 140 includes an autonomous parking controller 142 which is started when the autonomous parking event is performed. The details of the function of the autonomous parking controller 142 will be described later.

The second controller 160 controls the travel driving force output device 200, the brake device 210, and the steering device 220 such that the vehicle M passes along the target trajectory generated by the action plan generator 140 as scheduled.

Referring back to FIG. 8, the second controller 160 includes, for example, an acquirer 162, a speed controller 164, and a steering controller 166. The acquirer 162 acquires information of a target trajectory (path points) generated by the action plan generator 140 and stores the generated information in a memory (not shown). The speed controller 164 controls the travel driving force output device 200 or the brake device 210 on the basis of a speed element pertained to the target trajectory stored in the memory. The steering controller 166 controls the steering device 220 on the basis of a curved state of the target trajectory stored in the memory. The processes of the speed controller 164 and the steering controller 166 are embodied, for example, in a combination of feed-forward control and feedback control. For example, the steering controller 166 performs feed-forward control based on a curvature of a road in front of the host vehicle M and feedback control based on separation from the target trajectory in combination.

The travel driving force output device 200 outputs a travel driving force (a torque) for allowing a vehicle to travel to driving wheels. The travel driving force output device 200 includes, for example, a combination of an internal combustion engine, an electric motor, and a transmission and an electronic controller (ECU) that controls them. The ECU controls the above-mentioned configuration on the basis of information input from the second controller 160 or information input from the driving operator 90.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of the information input from the second controller 160 or the information input from the driving operator 90 such that a brake torque based on a braking operation is output to vehicle wheels. The brake device 210 may include a mechanism for transmitting a hydraulic pressure generated by an operation of a brake pedal included in the driving operator 90 to the cylinder via a master cylinder as a backup. The brake device 210 is not limited to the above-mentioned configuration, and may be an electronically controlled hydraulic brake device that controls an actuator on the basis of information input from the second controller 160 such that the hydraulic pressure of the master cylinder is transmitted to the cylinder.

The steering device 220 includes, for example, a steering ECU and an electric motor. The electric motor changes a direction of turning wheels, for example, by applying a force to a rack-and-pinion mechanism. The steering ECU drives the electric motor on the basis of the information input from the second controller 160 or the information input from the driving operator 90 to change the direction of the turning wheels.

### [Autonomous Parking Event—Entrance]

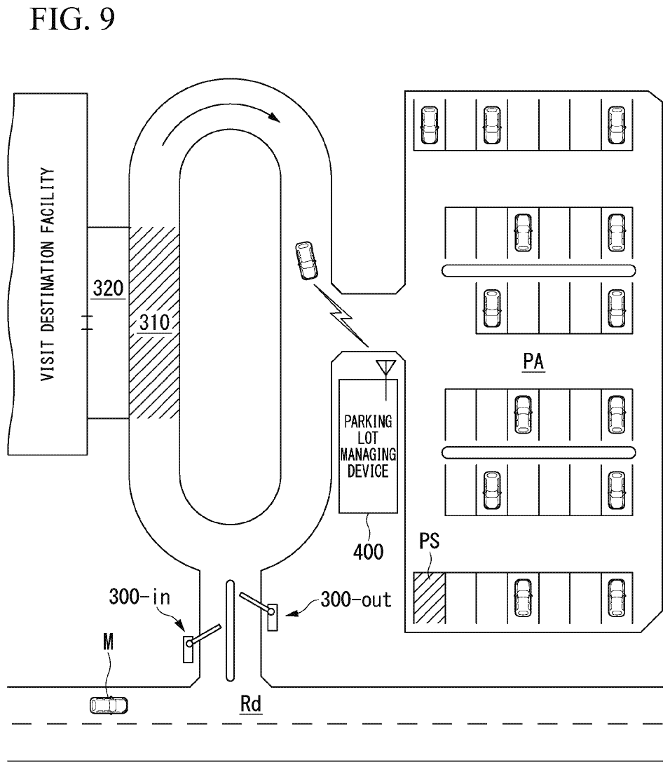

The autonomous parking controller 142 causes the vehicle M to park in a parking space, for example, on the basis of information acquired from a parking lot management device 400 via the communication device 20. FIG. 9 is a diagram schematically showing a scenario in which the autonomous parking event is performed according to the first embodiment. Gates 300-in and 300-out are provided in a route from a road Rd to a facility that is a visit destination. The vehicle M passes through the gate 300-in and travels to a stop area 310 by manual driving or automated driving. The stop area 310 is located in the vicinity of a boarding/alighting area 320 which is connected to the facility that is a visit destination. An awning for blocking snow or rain is provided in the boarding/alighting area 320.

The vehicle M starts an autonomous parking event of performing automated driving and moving to a parking space PS in a parking lot PA after an occupant has alighted in the stop area 310. A trigger for starting the autonomous parking event may be, for example, a certain operation of an occupant or may be reception of a predetermined signal from the parking lot management device 400 by radio communication. When the autonomous parking event is started, the autonomous parking controller 142 controls the communication device 20 such that a parking request is transmitted to the parking lot management device 400. Then, the vehicle M moves from the stop area 310 to the parking lot PA while sensing the surroundings according to guidance of the parking lot management device 400 or autonomously.

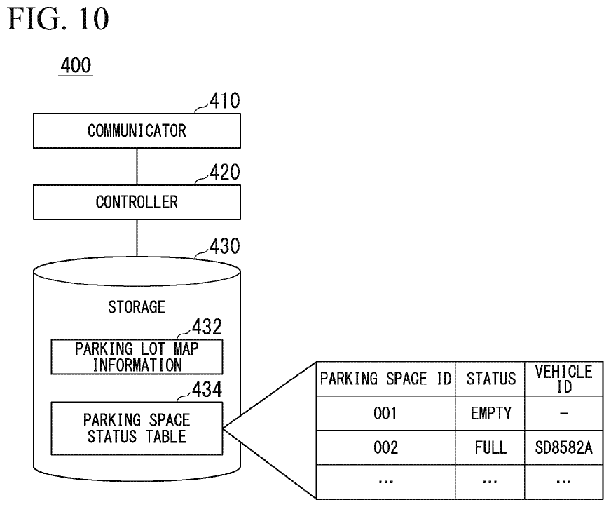

FIG. 10 is a diagram showing an example of the configuration of the parking lot management device 400 according to the first embodiment. The parking lot management device 400 includes, for example, a communicator 410, a controller 420, and a storage 430. Information such as parking lot map information 432 and a parking space status table 434 is stored in the storage 430.

The communicator 410 communicates with the vehicle M or other vehicles wirelessly. The controller 420 guides a vehicle to a parking space PS on the basis of information acquired by the communicator 410 and information stored in the storage 430. The parking lot map information 432 is information geometrically representing the structure of the parking lot PA. The parking lot map information 432 includes coordinates of each parking space PS. In the parking space status table 434, for example, a parking space ID which is identification information of a parking space PS is correlated with information indicating whether the parking space with the parking space ID is empty or full (parked) and a vehicle ID which is identification information of a vehicle parked at the parking space are correlated with each other.

When the communicator 410 receives a parking request from a vehicle, the controller 420 extracts a parking space PS of which the status is an empty status with reference to the parking space status table 434, acquires the position of the extracted parking space PS from the parking lot map information 432, and transmits a suitable route to the acquired position of the parking space PS to the vehicle via the communicator 410. The controller 420 instructs specific vehicles to stop or move slowly if necessary such that the vehicles do not enter the same position at the same time on the basis of a positional relationship between a plurality of vehicles.

In a vehicle having received a route (hereinafter, referred to as a vehicle M), the autonomous parking controller 142 generates a target trajectory based on the route. When the parking space PS which is a target is approached, the parking space recognizer 132 recognizes a parking frame line defining the parking space PS or the like, recognizes a detailed position of the parking space PS, and provides the recognized detailed position to the autonomous parking controller 142. The autonomous parking controller 142 receives the detailed position, corrects the target trajectory, and causes the vehicle M to be parked in the parking space PS.

### [Autonomous Parking Event—Exit]

The autonomous parking controller 142 and the communication device 20 keep operating even when the vehicle M is parked. For example, when the communication device 20 receives a pickup request from a terminal device of an occupant, the autonomous parking controller 142 starts the system of the vehicle M and moves the vehicle M to the stop area 310. At this time, the autonomous parking controller 142 controls the communication device 20 such that a departure request is transmitted to the parking lot management device 400. Similarly to entrance, the controller 420 of the parking lot management device 400 instructs specific vehicles to stop or move slowly if necessary such that the vehicles do not enter the same position at the same time on the basis of a positional relationship between a plurality of vehicles. When the vehicle M is moved to the stop area 310 and an occupant boards the vehicle M, the autonomous parking controller 142 stops its operation and then manual driving or automated driving using other functional units is started.

The invention is not limited to the above description, and the autonomous parking controller 142 may not depend on communication, but may search for an empty parking space on the basis of the results of detection from the camera 10, the radar device 12, the finder 14, or the object recognition device 16 and park the vehicle M in the searched parking space.

### [Operation Flow of Display Device]

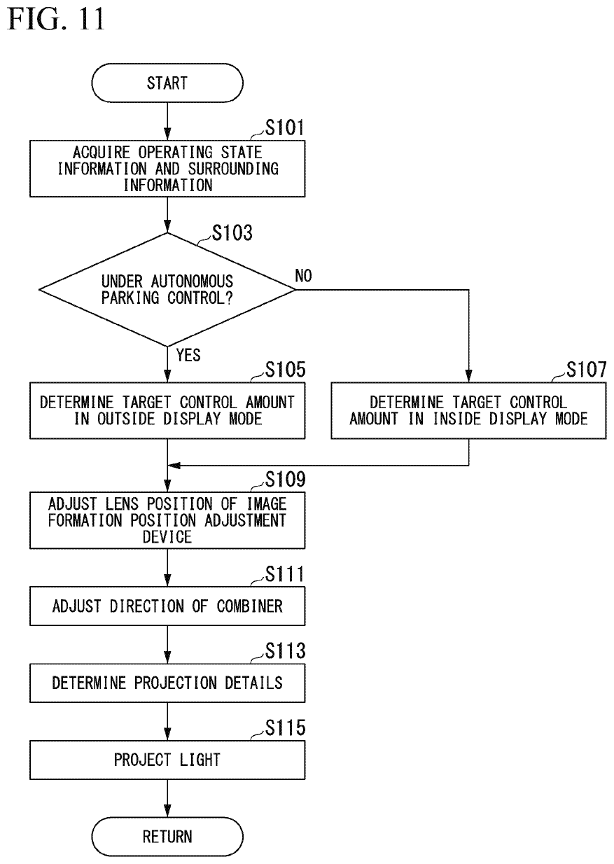

An operation flow of the HUD device 70 will be described below. FIG. 11 is a flowchart showing an example of an operation flow which is performed by the HUD device 70 according to the first embodiment. First, the acquirer 81 acquires operating state information indicating an operating state of a vehicle M and surrounding information of the vehicle M which are output from the automated driving control device 100 (Step S101). The acquirer 81 acquires information indicating a position (a sight line position) of a person outside the vehicle M as the surrounding information.

Then, the determiner 82 determines whether the vehicle M is under autonomous parking control on the basis of the operating state information acquired by the acquirer 81 (Step S103). When the determiner 82 determines that the vehicle M is under autonomous parking control, the target control amount determiner 83 determines target control amounts including a target virtual image visible distance D_{TA} and a target elevation/depression angle θ_{TA} in the outside display mode on the basis of the surrounding information acquired by the acquirer 81 (Step S105).

On the other hand, when the determiner 82 determines that the vehicle M is not under autonomous parking control, the target control amount determiner 83 determines target control amounts including a target virtual image visible distance D_{TA} and a target elevation/depression angle θ_{TA} in the inside display mode (Step S107).

Then, the drive controller 84 outputs a control signal based on the target virtual image visible distance D_{TA} determined by the target control amount determiner 83 to the image formation position adjustment device 72A, and the image formation position adjustment device 72A adjusts a position of each lens on the basis of the control signal input from the drive controller 84 (Step S109).

Then, the drive controller 84 outputs a control signal based on the target elevation/depression angle θ_{TA} determined by the target control amount determiner 83 to the actuator 74, and the actuator 74 adjusts the direction of the combiner 73 in the Y-axis direction on the basis of the control signal input from the drive controller 84 (Step S111). Accordingly, under control in the outside display mode, an image formed by the image light IL is adjusted to be displayed at the formation apposition P4 when seen from the sight line position P3 of the person outside the vehicle. Under control in the inside display mode, an image formed by the image light IL is adjusted to be displayed at the formation apposition P2 when seen from the sight line position P1 of the driver.

Then, the projection controller 85 determines projection details which are projected to the combiner 73 on the basis of the results of determination from the determiner 82 (Step S113). For example, when the determiner 82 determines that the vehicle M is under autonomous parking control (under automatic exiting), the projection controller 85 determines an image including characters “under automatic exiting” which is notified to the person outside the vehicle as projection details. For example, when the determiner 82 determines that the vehicle M is not under automatic exiting, the projection controller 85 determines information for supporting driving for the driver (for example, an image including characters indicating the speed of the vehicle M) as projection details.

Then, the projection controller 85 performs a projection process on the basis of the determined projection details (Step S115). Thereafter, the operating state information and the surrounding information are acquired again (Step S101) and the processes subsequent thereto are repeatedly performed.

According to the first embodiment, a person outside of the vehicle can easily understand the status of a vehicle which is being automatically parked. For example, by notifying the status of the vehicle which is being automatically parked using the HUD device, it is possible to notify a person outside of the vehicle of a status of a vehicle which is being automatically parked without providing a separate outside notification function or a dedicated notification unit.

### Second Embodiment

Hereinafter, a second embodiment will be described. The HUD device 70 according to the second embodiment is different from that according to the first embodiment in that a display mode of a virtual image VI is set to be variable. Accordingly, the drawings described in the first embodiment and description associated therewith are invoked for the elements thereof or the like and detailed description thereof will not be repeated.

### [Operation Flow of Display Device]

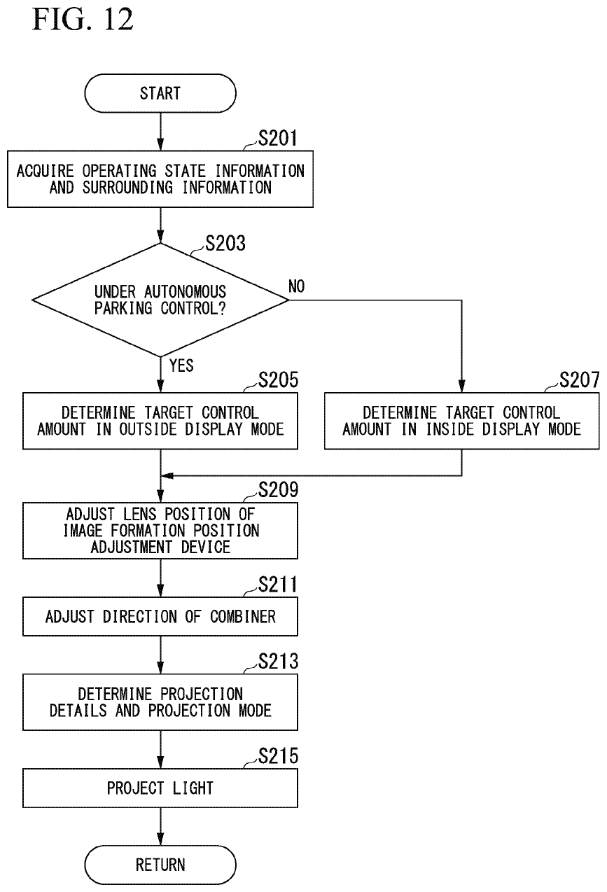

An operation flow of the HUD device 70 will be described below. FIG. 12 is a flowchart showing an example of an operation flow which is performed by the HUD device 70 according to the second embodiment. First, the acquirer 81 acquires operating state information indicating an operating state of a vehicle M and surrounding information of the vehicle M which are output from the automated driving control device 100 (Step S201). The acquirer 81 acquires information indicating a speed, acceleration, and the like of the vehicle M as the operating state information. The acquirer 81 acquires information indicating outside brightness (light intensity), information indicating the weather, and the like in addition to information indicating a position (a sight line position) of a person outside the vehicle M as the surrounding information.

Then, the determiner 82 determines whether the vehicle M is under autonomous parking control on the basis of the operating state information acquired by the acquirer 81 (Step S203). When the determiner 82 determines that the vehicle M is under autonomous parking control, the target control amount determiner 83 determines target control amounts including a target virtual image visible distance D_{TA} and a target elevation/depression angle θ_{TA} in the outside display mode on the basis of the surrounding information acquired by the acquirer 81 (Step S205).

On the other hand, when the determiner 82 determines that the vehicle M is not under autonomous parking control, the target control amount determiner 83 determines target control amounts including a target virtual image visible distance D_{TA} and a target elevation/depression angle θ_{TA} in the inside display mode (Step S207).

Then, the drive controller 84 outputs a control signal based on the target virtual image visible distance D_{TA} determined by the target control amount determiner 83 to the image formation position adjustment device 72A, and the image formation position adjustment device 72A adjusts a position of each lens on the basis of the control signal input from the drive controller 84 (Step S209).

Then, the drive controller 84 outputs a control signal based on the target elevation/depression angle θ_{TA} determined by the target control amount determiner 83 to the actuator 74, and the actuator 74 adjusts the direction of the combiner 73 in the Y-axis direction on the basis of the control signal input from the drive controller 84 (Step S211). Accordingly, under control in the outside display mode, an image formed by the image light IL is adjusted to be displayed at the formation apposition P4 when seen from the sight line position P3 of a person outside of the vehicle. Under control in the inside display mode, an image formed by the image light IL is adjusted to be displayed at the formation apposition P2 when seen from the sight line position P1 of the driver.

Then, the projection controller 85 determines projection details which are projected to the combiner 73 and a projection mode thereof on the basis of the results of determination from the determiner 82 (Step S213).

### [Relationship Between Ambient Light Intensity and Luminance of Virtual Image VI]

Under control in the outside display mode, the projection controller 85 determines a projection mode such that luminance of a virtual image VI increases when the surroundings of the vehicle M becomes brighter (when the ambient light intensity is equal to or greater than a predetermined threshold value or the like). The projection controller 85 determines a projection mode such that luminance of the virtual image VI decreases when the surroundings of the vehicle M becomes darker (when the ambient light intensity is less than a predetermined threshold value or the like). Accordingly, it is possible to improve visibility of a virtual image VI by a person outside the vehicle. That is, the projection controller 85 controls the light projection device 71 such that the luminance of projection light increases as the surroundings of the vehicle M become brighter.

The projection controller 85 may determine the projection mode on the basis of the weather around the vehicle M under control in the outside display mode. For example, when the weather around the vehicle is fair, the projection controller 85 may determine the projection mode such that the luminance of the virtual image VI increases under control in the outside display mode. When the weather around the vehicle M is rainy or cloudy, the projection controller 85 may determine the projection mode such that the luminance of the virtual image VI decreases.

### [Relationship Between Vehicle Speed and Blinking Pattern of Virtual Image VI]

Under control in the outside display mode, the projection controller 85 determines the projection mode such that a blinking period of the virtual image VI increases when the speed of the vehicle M becomes lower (when the speed is less than a predetermined threshold value or the like). The projection controller 85 determines the projection mode such that the blinking period of the virtual image VI decreases when the speed of the vehicle M becomes higher (when the speed is equal to or greater than a predetermined threshold value or the like). Accordingly, it is possible to improve visibility of a virtual image VI by a person outside the vehicle. That is, the projection controller 85 controls the light projection device 71 such that the blinking period of projection light increases as the speed of the vehicle M becomes lower.

Then, the projection controller 85 performs a projection process on the basis of the determined projection details and the determined projection mode (Step S215). Thereafter, the operating state information and the surrounding information are acquired again (Step S201) and the processes subsequent thereto are repeatedly performed.

According to the second embodiment, a person outside the vehicle can easily understand a status of a vehicle which is being automatically parked. For example, by notifying of a status of a vehicle which is being automatically parked using the HUD device, it is possible to notify a person outside the vehicle of a status of a vehicle which is being automatically parked without providing a separate outside notification function or a dedicated notification unit. By setting the display mode of a virtual image VI to be variable, it is possible to more effectively notify a person outside the vehicle of a status of a vehicle.

The projection controller 85 may perform a projection process only when the surroundings of the vehicle M are dark (when the ambient light intensity is equal to or less than a predetermined threshold value or the like). The projection controller 85 may determine whether there is a person outside the vehicle M and perform the projection process only when a person is present.

In the above-mentioned embodiments, image light IL is projected to the combiner 73, but image light IL may be projected to the front windshield 303. In this case, the projection direction may be controlled by rotating the concave mirror 72C around the Y axis which is parallel to the width direction of the vehicle M.

When the determiner 82 determines that the vehicle M is under autonomous parking control (under automatic exiting) and approaches the stop area 310, the projection controller 85 may determine an image including details for causing an occupant waiting for the vehicle M in the stop area 310 to identify the vehicle (an image indicating a symbol, a color, or the like which enables the occupant to identify the vehicle) as projection details, and display the determined projection details to the outside.

In the above-mentioned embodiments, the display control device 75 controls the combiner 73 and the actuator 74 such that a direction of projection light is adjusted, but the invention is not limited thereto. For example, the display control device 75 may adjust the direction of projection light by electrically controlling reflectance (transmittance), a refractive index, or the like of projection light in the combiner 73 of which the direction has been fixed instead of using the actuator 74. For example, the display control device 75 may cause the projection light to be reflected by a surface of the combiner 73 facing the inside when the projection light is visually recognized by an occupant, and may invert an image, project the inverted image to the combiner 73, cause the image to be transmitted by a surface of the combiner 73 facing the inside and to be refracted and transmitted toward the person outside the vehicle by the surface of the combiner 73 facing the outside when the projection light is visually recognized by the person outside the vehicle.

### [Hardware Configuration]

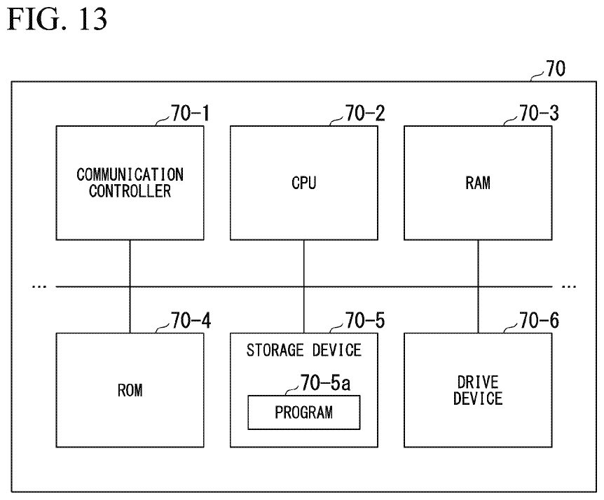

FIG. 13 is a diagram showing an example of a hardware configuration of the display control device 75 according to the embodiment. As shown in the drawing, the display control device 75 has a configuration in which a communication controller 75-1, a CPU 75-2, a random access memory (RAM) 75-3 which is used as a work memory, a read only memory (ROM) 75-4 that stores a booting program or the like, a storage device 75-5 such as a flash memory or a hard disk drive (HDD), a drive device 75-6, and the like are connected to each other via an internal bus or a dedicated communication line. The communication controller 75-1 communicates with elements other than the display control device 75. A program 75-5a which is executed by the CPU 75-2 is stored in the storage device 75-5. This program is loaded into the RAM 75-3 by a direct memory access (DMA) controller (not shown) or the like and is executed by the CPU 75-2. Accordingly, some or all of the elements of the controller 80 are embodied.

The above-mentioned embodiments can be expressed as follows: a display device that is mounted in a vehicle, the display device including: a light projection device that emits projection light; an adjuster that adjusts a direction of the projection light emitted by the light projection device; a storage device that stores a program; and a hardware processor, wherein, by executing the program stored in the storage device, the hardware processor is configured to control the adjuster such that the direction of the projection light changes according to whether the vehicle travels by autonomous parking control or whether the vehicle travels without using autonomous parking control.

While the invention has been described with reference to an embodiment, the invention is not limited to the embodiment and can be subjected to various modifications and substitutions without departing from the gist of the invention.

What is claimed is:

1. A display device that is mounted in a vehicle, the display device comprising:
a light projection device configured to emit projection light;
an adjuster configured to adjust a direction of the projection light emitted by the light projection device; and
a control device configured to control the light projection device and the adjuster,
wherein the control device is configured to control the adjuster to change the direction of the projection light according to whether the vehicle travels by autonomous parking control or whether the vehicle travels without using the autonomous parking control.

2. The display device according to claim 1, wherein
the adjuster comprises a reflecting plate configured to reflect the projection light and an actuator configured to change a direction of the reflecting plate, and
the control device is configured to control the actuator to change a reflecting direction of the projection light reflected by the reflecting plate according to whether the vehicle travels by the autonomous parking control or whether the vehicle travels without using the autonomous parking control.

3. The display device according to claim 2, wherein
the control device is configured to control the actuator to output the projection light reflected by the reflecting plate to an outside of the vehicle in a case where the vehicle travels by the autonomous parking control.

4. The display device according to claim 2, wherein
the control device is configured to control the actuator to make the projection light reflected by the reflecting plate be visible to a person outside the vehicle on the basis of position information of the person.

5. The display device according to claim 2, wherein
the control device is configured to control the actuator to make the projection light reflected by the reflecting plate be visible to a person outside the vehicle on the basis of a sight line position of the person.

6. The display device according to claim 1, wherein
the projection light includes information for displaying an image indicating an operating state of the vehicle.

7. The display device according to claim 2, wherein
the reflecting plate is a head-up display device.

8. The display device according to claim 1, wherein
the control device is configured to control the light projection device to change a projection mode of the projection light on the basis of brightness outside the vehicle.

9. The display device according to claim 8, wherein
the control device is configured to control the light projection device to increase luminance of the projection light as outside of the vehicle becomes brighter.

10. The display device according to claim 1, wherein
the control device is configured to control the light projection device to change a projection mode of the projection light on the basis of weather outside the vehicle.

11. The display device according to claim 1, wherein
the control device is configured to control the light projection device to change a projection mode of the projection light on the basis of a speed of the vehicle.

12. The display device according to claim 11, wherein
the control device is configured to control the light projection device to increase a blinking period of the projection light as the speed of the vehicle decreases.

13. The display device according to claim 1, wherein
the control device is configured to control the light projection device to emit the projection light only in a case where a light intensity outside the vehicle is equal to or less than a predetermined threshold value.

14. The display device according to claim 1, wherein
the control device is configured to control the light projection device to prevent from emitting the projection light in a case where there are no persons outside the vehicle.

15. A display control method of causing a computer of a display device, which is mounted in a vehicle and comprises a light projection device configured to emit projection light and an adjuster configured to adjust a direction of the projection light emitted by the light projection device, to control the adjuster to change the direction of the projection light according to whether the vehicle travels by autonomous parking control or whether the vehicle travels without using the autonomous parking control.

16. A non-transitory computer-readable storage medium storing a program, the program causing a computer of a display device, which is mounted in a vehicle and comprises a light projection device configured to emit projection light and an adjuster configured to adjust a direction of the projection light emitted by the light projection device, to control the adjuster to change the direction of the projection light according to whether the vehicle travels by autonomous parking control or whether the vehicle travels without using the autonomous parking control.
